(19) United States
(12) Patent Application Publication
(10) Pub. No.: US 2022/0233943 A1
(43) Pub. Date: Jul. 28, 2022

(54) Interactive Pitching Training Apparatus and System

(71) Applicants: William A. Brant, Boerne, TX (US); Robert T. Peacock, Falls Church, VA (US)

(72) Inventors: William A. Brant, Boerne, TX (US); Robert T. Peacock, Falls Church, VA (US)

(21) Appl. No.: 17/155,137

(22) Filed: Jan. 22, 2021

(51) Int. Cl. A63B 71/06; A63B 69/00; A63B 63/00; A63B 24/00

(52) U.S. Cl. CPC A63B 71/0669; A63B 69/0002; A63B 63/00; A63B 2220/53; A63B 2069/0006; A63B 2220/36; A63B 24/0003

(57) ABSTRACT

A pitching interactive training system having of a mat against which a ball is thrown. The mat has an embedded electronic display of a strike zone broken down into subsidiary “zones” and an exterior perimeter of “zones” just outside the strike zone. The embedded sensors and electronics when hit with a pitch register a point value on a scoreboard. Assignment of values may be adjusted for each pitch by remote control for each batter depending upon the game situation. The electronic scoreboard registers whether a ball or a strike and values for each pitch and maintains a total score with a reset for each new batter. The embedded electronics and scoreboard are powered by battery and rechargeable via an attached electric cord plugged into a standard electrical outlet. An optional radar gun records the speed of each pitch. An optional high speed sports camera attached to the system allows measurement of pitch spin rotations, pitch release point, and captures the entire pitch delivery process for replay to aid coaching and visualizing pitch command.

### BACKGROUND OF THE INVENTION

Baseball, America's pastime, starts with a pitch from a pitcher. Pitching is both an art and a science. The art of pitching involves command/control by the pitcher of each pitch thrown. Command is the ability to pitch to specific locations depending primarily on the specific batter and game situation. Command encompasses hitting a specific spot with each type of pitch in a pitcher's repertoire.

Numerous devices and systems have been utilized to enhance pitching performance. One such device is described in U.S. Patent Publication No. U.S. 2006/0243929 A1 (Mc Daniel). An air mattress is provided with a plurality of air valves Signaling devices alert when a strike air valve activates and when a ball air valve activates so as a user knows whether a pitch is a ball or a strike.

Another such device is described in U.S. Pat. No. U.S. 2004/0127308 A1 (Swanson). In this device a multilayered pitching target is disclosed. Marked squares designate ball and strike zones. Ball impacts leave indentations in the target.

The present invention relates to an interactive system (also herein sometimes referred to as a PITCHmat). The PITCHmat is intended to primarily emphasize and enhance a pitcher's command of his or her pitches. It trains the pitcher to locate and hit specific “zones” tallying points for each pitch developing command.

Again, the main focus of the invention is to serve as a baseball/softball teaching and coaching tool and the mat or screen of the present invention normally will be set up 60′ 6″ (MLB baseball) or 43′ (high school/college softball) from the pitcher (the distance from the “mound”/front of the pitching rubber to home plate). However, the system may also serve to teach basic coordination skills as a “target” for younger players at any distance and for game/recreational purposes in gymnasiums, dens and other athletic/recreational indoor/outdoor venues for “players” of all ages with the competitors seeking to achieve the highest score. Softer balls/projectiles such as tennis balls will usually be substituted for baseballs/softballs in the latter usages/venues. Unlike existing dart board games, the “values” assigned in the scoring will not be “fixed” but may be electronically revised requiring the players to adjust their throwing motions/mechanics to strike the changing values and maximize their score.

The present invention may be further modified to function as an interactive game as described below.

### SUMMARY OF THE INVENTION

The Pitching Interactive Training Mat (PITCHmat or PMAT) consists of a mat or screen against which a projectile such as a baseball or softball is thrown. The PITCHmat has a graphic display of a strike zone broken down into nine subsidiary “zones” and an exterior perimeter of sixteen “zones” surrounding the strike zone. Beneath each zone are embedded sensors and electronics which when impacted with pitched ball registers a point value, for example, from 1 to 10, on the integrated, attached scoreboard.

The embedded sensors (whether pressure sensors or electronic sensors) and associated electronics are well known in the art and are comparable to the “touch pads” used in computers, smart phones, video games, and the like.

Assignment of the point values may be adjusted for each pitch by a cooperating remote control device for each batter depending upon the game situation. A complimentary scoreboard electronically connected to the mat will register whether a ball or a strike is thrown, values for each pitch thrown, and maintains a total score which may be reset for each new batter. The embedded electronics and scoreboard may be powered by battery and may be rechargeable via an attached electric cord plugged into standard electrical outlets. An optional radar gun records the speed of each pitch. Optional high speed sports cameras may be attached to the mat and/or as a stand-alone allowing for measurement of pitch spin rotations, pitch release point, and capturing the entire pitch delivery process for replay to aid coaching and visualizing pitch command.

### BRIEF DESCRIPTION OF THE DRAWINGS

FIG. 1 illustrates an embodiment of the mat or screen of the present invention.

FIG. 2 shows a top plan view of the mat of the present invention.

FIG. 3 illustrates a side elevation view of the mat.

FIG. 4 illustrates the relationship of the various zones on the mat to a representative batter, catcher, and umpire. The strike zone is shaded.

FIG. 4A shows a top view of a home plate with the width dimensions of the strike zone.

FIG. 5 illustrates the relationship of the various element of the present training system in actual usage.

FIG. 6 illustrates an arrangement of the electrical subassemblies of the present invention.

### DETAILED DESCRIPTION OF A PREFERRED EMBODIMENT

The present disclosure will be described with respect to particular embodiments and with references to certain drawings, but the disclosure is not limited thereto. The drawings are only schematic and are non-limiting. In the drawings, size of some of the elements may be exaggerated for illustrative purposes and not drawn on scale. Specific and relative dimensions do not necessarily correspond to actual reductions to practice of the disclosure. The various embodiments are solely examples and are not limiting the scope of the invention.

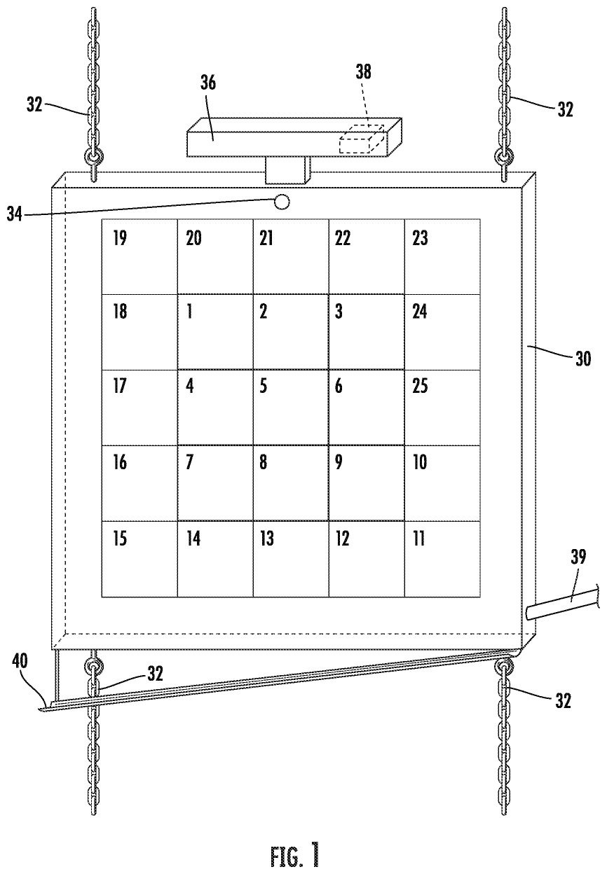

FIG. 1 shows a front view of the PITCHmat mat or screen30 suspended by adjustable straps 32 above a home plate (not shown) with a integral camera subsystem 34, a scoreboard display 36 having an impact counter and system controller subsystem 38, and an incoming electric power source 39. A ball catchment trough 40 is attached beneath the mat to serve as a ball retrieval system.

The mat 30 has nine numbered square mini zones or tiles (tiles numbered 1-9) within the overall typical “strike zone.” Outside the strike zone are sixteen additional mini-zones, called chase tiles, (tiles numbered 10-25) along the periphery of the “strike zone.” Because it is often important to entice the batter to “chase” pitches outside the strike zone, these chase zones/tiles tiles are important to the development of a pitcher. When the ball is thrown and strikes a tile, an embedded electronic sensor beneath that particular tile transmits the assigned numerical value or score for the struck tile and whether a ball or a strike to the electronic scoreboard.

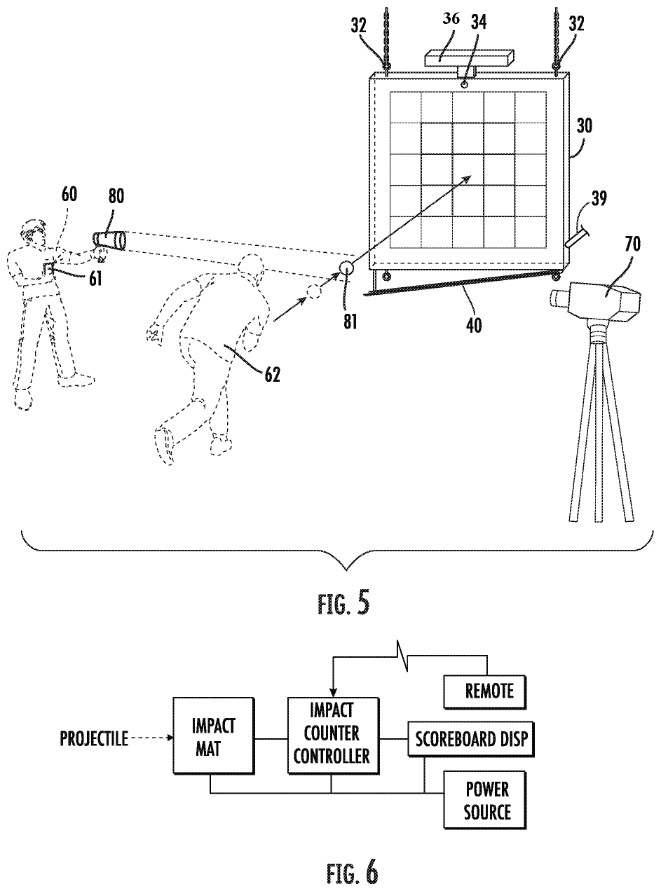

When pitching with a coach 60 (FIG. 5), the coach will generally assign numbers via the ancillary remote control device 61 to tiles/zones before the pitch and depending upon the simulated baseball situation. For example, with runners on first and third bases and less than two outs a coach might call for a pitch-out (ball pitched high and outside) assigning tile number 23 (FIG. 1) a ten-point value when hit with the pitched ball. This allows pitchers/coaches to present simulated game situations while pitchers 62 practice pitch command and pitching to zones considered most likely to achieve the best result for that situation. The training capability enhances the value of the PITCHmat for coaching and increasing the pitcher's knowledge of the best pitching strategies for specific game situations.

The PITCHmat is also designed for use by a pitcher without a coach. In such cases, the PITCHmat zones/tiles may have pre-assigned or randomly-assigned numbers or the pitcher can remotely assign specific values before pitching as desired.

When pitching alone, a pitcher may pitch by pitch count. Typically, a bucket of twenty-four balls (baseballs or softballs) will be pitched with six pitches assigned per simulated batter. At the end of twenty-four pitches the pitcher will retrieve or “shag” the balls from the Ball Retrieval System (BRS) or the ball catchment trough 40 and continue. Shagging balls four times results in a pitch count of ninety-six pitches, which would generally be a maximum limit for young pitchers. Pitch count limits should be set according to a player's age and ability.

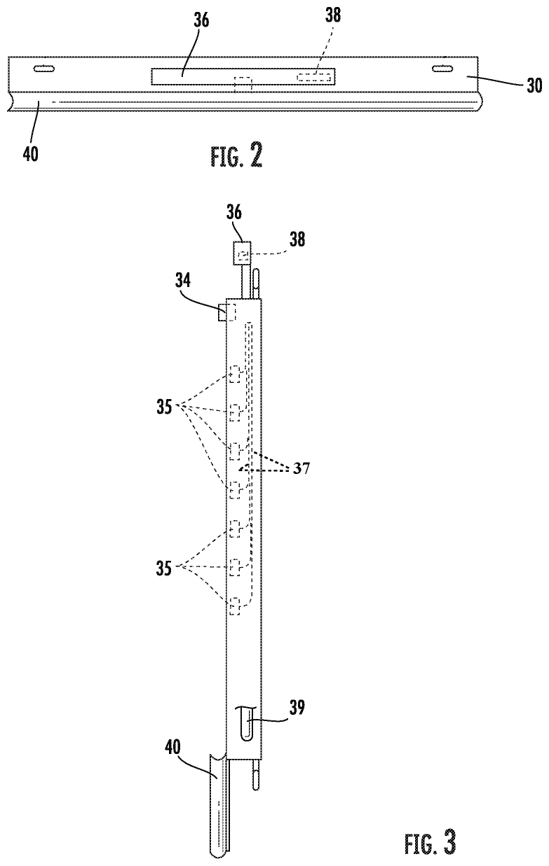

FIG. 2 illustrates a top, plan view of the mat 30 with the ball catchment trough 40, the scoreboard 36, the impact counter and system controller subsystem 38, and camera 34.

FIG. 3 shows a left, side, elevation view of the mat 30 illustrating the scoreboard 36, the camera 34, various impact sensors 35 and sensor connective wiring 37 (in broken lines), the ball retrieval system 40, and the power supply source 39. Details of the electrical connections are well known in the field and are understood by those of ordinary skill in the art.

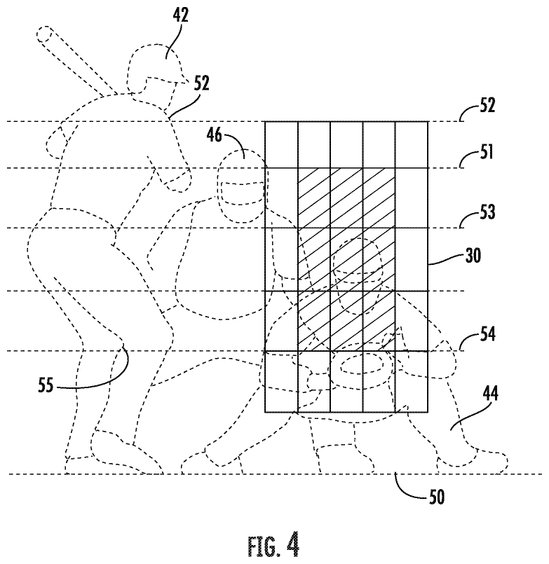

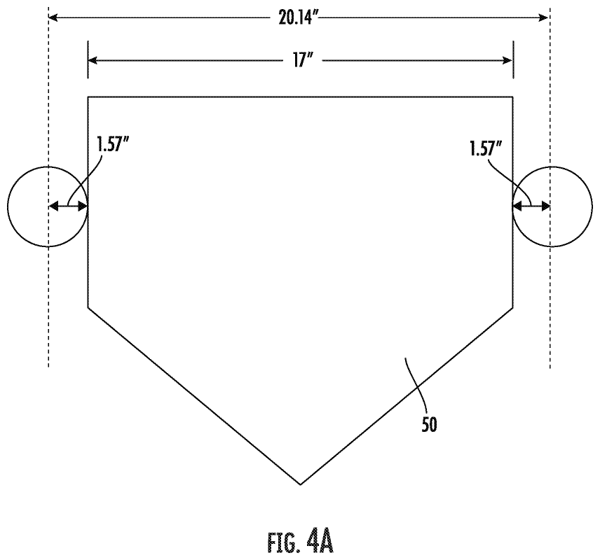

Fig.4 illustrates the typical batter 42, catcher 44, and umpire 46 positions above home plate 50. A visual representation of the mat 30 of the present invention is superimposed in the figure to show the various zones/tiles relative to these characters in the typical battery. The strike zone (the shaded portion of FIG. 4) is the area over home plate 50 (See FIG. 4A). Its upper limit is a horizontal line 51 at the midpoint between the top of the batter's shoulder 52 and the top of the uniform pants 53. Its lower level is a line 54 at the hollow 55 beneath the batter's knee cap. The strike zone is determined from the batter's stance as he prepares to swing at a pitch.

FIG. 4A shows a top view of home plate 50 showing the width of the strike zone and the “outside” limits illustrated by one half the ball's diameter.

FIG. 5 illustrates the present system set up for pitching balls at the mat. The mat or screen 30 of the present invention normally will be set up 60′ 6″ (MLB baseball) or 43′ (high school/college softball) from the pitcher 62 (the distance from the “mound”/front of the pitching rubber to home plate). As illustrated in FIG. 5, an optional ancillary high speed sports action camera 70 videos and permits review and analysis by coaches 60 and/or pitchers 62 of pitches thrown and the overall delivery process. An optional (off the shelf) radar gun 80 may be used to record the speed of the ball 81 pitched. An integral camera 34 allows for measurement of pitch spin rotations, pitch release point, and captures the entire pitch delivery process for replay to aid coaching and visualizing pitch command.

FIG. 6 is a simplified block diagram of the electrical subassemblies/components of the present system. One of ordinary skill in the art would understand these components.

Having now described the invention in conjunction with particularly illustrated embodiments thereof, variations and modifications may now naturally occur from time to time to those persons normally skilled in the art without departing from the essential scope or spirit of the invention, and accordingly it is intended to claim the same broadly as well as specifically as indicated by the appended claims.

1. An interactive system for a player to improve pitching or throwing a ball comprising:
a ball for throwing;
an electronically powered ball impact absorbing mat for receiving a thrown ball, said mat having a front face having a graphic design thereon with a first plurality of central strike zone representations and a second plurality of peripheral ball zone representations;
a plurality of electronically powered impact sensors embedded beneath said front face of said mat, at least one of said plurality of impact sensors embedded beneath each of said strike zone representations and each of said peripheral ball zone representations;
an electronic scoreboard operatively connected to each of said plurality of impact sensors for sensing thrown ball impacts in said ball and strike zone representations, each of said plurality of impact sensors programmable to transmit an assigned value for each thrown ball impact sensed to an impact counter associated with said scoreboard for counting and registering balls and strikes and a value of said thrown ball impacts on said scoreboard;
a power source for powering said system of said mat, said impact sensors, said counter, and said scoreboard, and
a remote controller for remotely varying said assigned value for each thrown ball impact sensed.

2. The system of claim 1 wherein the remote controller is configured for remotely assigning said assigned value for each of the strike zone representations and ball zone representations.

3. The system of claim 2 wherein said impact sensors are pressure sensors.

4. The system of claim 3 further comprising
a camera subsystem for observing, recording, and displaying ball dynamics of balls thrown at said mat by said player.

5. The system of claim 3 further comprising
a radar gun capable of being aimed at ball flight of a thrown ball for registering the speed of said thrown ball.

6. The system of claim 3 further comprising
a high speed camera subsystem for observing, recording and displaying motion dynamics of said player throwing said ball.

7. An interactive system for training a player to improve pitching or throwing a ball comprising:
a ball for throwing;
an electronically powered ball impact absorbing mat for receiving a thrown ball, said mat having a front face having a graphic design thereon with nine central strike zone representations and sixteen peripheral ball zone representations;
a plurality of electronically powered pressure sensors embedded beneath said front face of said mat, at least one of said plurality of pressure sensors embedded beneath each of said nine strike zone representations and each of said sixteen peripheral ball zone representations;
an electronic scoreboard operatively connected to each of said plurality of pressure sensors for sensing thrown ball impacts in said ball and strike zone representations, each of said plurality of pressure sensors programmable to transmit an assigned value for each thrown ball impact sensed to an impact counter associated with said scoreboard for counting and registering a value of said thrown ball impacts on said scoreboard;
a power source for powering said system of said mat, said sensors, said counter, and said scoreboard;
a remote controller for remotely varying said assigned value for each thrown ball impact sensed;
a camera subsystem for observing, recording, and displaying ball dynamics of balls thrown at said mat by said player;
a radar gun capable of being aimed at ball flight of a thrown ball for registering the speed of said thrown ball; and
a high speed camera subsystem for observing, recording and displaying motion dynamics of said player throwing said ball.

8. The interactive system of claim 7, wherein the remote controller is configured for remotely assigning said assigned values for each of the strike zone representations and ball zone representations.
